(19) United States
(12) Patent Application Publication
(10) Pub. No.: US 2024/0122090 A1
(43) Pub. Date: Apr. 18, 2024

(54) PRECISION FARMING SYSTEM WITH SUSTAINABILITY MEASURE

(71) Applicant: Trace Genomics, Inc., Redwood City, CA (US)

(72) Inventors: Ronald O. Zink, Mercer Island, WA (US); Maria Mooshammer, El Cerrito, CA (US); Poornima Parameswaran, Menlo Park, CA (US)

(21) Appl. No.: 18/046,124

(22) Filed: Oct. 12, 2022

(51) Int. Cl. A01B 79/00; A01G 9/14

(52) U.S. Cl. CPC A01B 79/005; A01G 9/14

(57) ABSTRACT

A method of selecting a treatment recommendation to improve sustainable farming of a field includes obtaining soil from the field and measuring biologic content in the soil. The biologic content is used to determine an ability of the soil to sequester a greenhouse gas and the ability of the soil to sequester the greenhouse gas is used to select a treatment recommendation to increase the ability of the soil to sequester the greenhouse gas.

### BACKGROUND

Precision farming systems identify field conditions so that treatments can be applied to the field to maximize the next harvest.

The discussion above is merely provided for general background information and is not intended to be used as an aid in determining the scope of the claimed subject matter. The claimed subject matter is not limited to implementations that solve any or all disadvantages noted in the background.

### SUMMARY

A method of selecting a treatment recommendation to improve sustainable farming of a field includes obtaining soil from the field and measuring biologic content in the soil. The biologic content is used to determine an ability of the soil to sequester a greenhouse gas and the ability of the soil to sequester the greenhouse gas is used to select a treatment recommendation to increase the ability of the soil to sequester the greenhouse gas.

In accordance with a further embodiment, a method of selecting a treatment recommendation for a field includes obtaining soil from the field and measuring biologic content in the soil. The biologic content is used to determine microbe biodiversity in the soil and the microbe biodiversity is used to select a treatment recommendation to increase the biodiversity in the soil.

In accordance with a still further embodiment, a method includes collecting soil samples from multiple fields and using the soil sample of each field to determine a sustainability score for the field. The sustainability score indicates the degree to which the field is capable of being farmed in a sustainable manner.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a system for generating a sustainability score and treatment recommendations based on a sustainability score from a soil sample

FIG. 2 is a flow diagram of a method of processing a soil sample using the system of FIG. 1.

FIG. 3 is a flow diagram of a method of performing biologic content tests.

FIG. 4 is a block diagram of a nutrient module.

FIG. 5 is a flow diagram of a method of determining a nutrient score.

FIG. 6 is a block diagram of a P score module.

FIG. 7 is a flow diagram of a method of determining a unified phosphorous measure.

FIG. 8 is a block diagram of a biologic N retention score module.

FIG. 9 is a flow diagram of a method of determining a biologic N retention score.

FIG. 10 is a block diagram of a biodiversity module.

FIG. 11. is a flow diagram of a method of determining a biodiversity score.

FIG. 12 is a block diagram of carbon module.

FIG. 13 is a flow diagram of a method of determining a carbon score.

FIG. 14 is a block diagram of a water module.

FIG. 15 is a flow diagram of a method of generating a user interface for a purchaser of crops.

FIG. 16 is an example user interface for a purchaser of crops.

FIG. 17 is a second example of a user interface for a purchaser of crops.

FIG. 18 is a third example of a user interface for a purchaser of crops.

FIG. 19 is a fourth example of a user interface for a purchaser of crops.

FIG. 20 provides a block diagram of a computing device used to implement the various embodiments.

### DETAILED DESCRIPTION

Precision farming systems to date have focused on maximizing the next harvest without accounting for the sustainability of current farming practices. In accordance with the various embodiments, a measure of the sustainability of current farming practices is determined by measuring certain characteristics of the field. These characteristics indicate the ability of the field to retain water, to retain nutrients and make those nutrients available to plants, to sequester greenhouse gases and to maintain biodiversity within the field. These characteristics are combined to form a sustainability score that can be used to compare fields to each other and to recommend treatments that will improve the sustainability of a field.

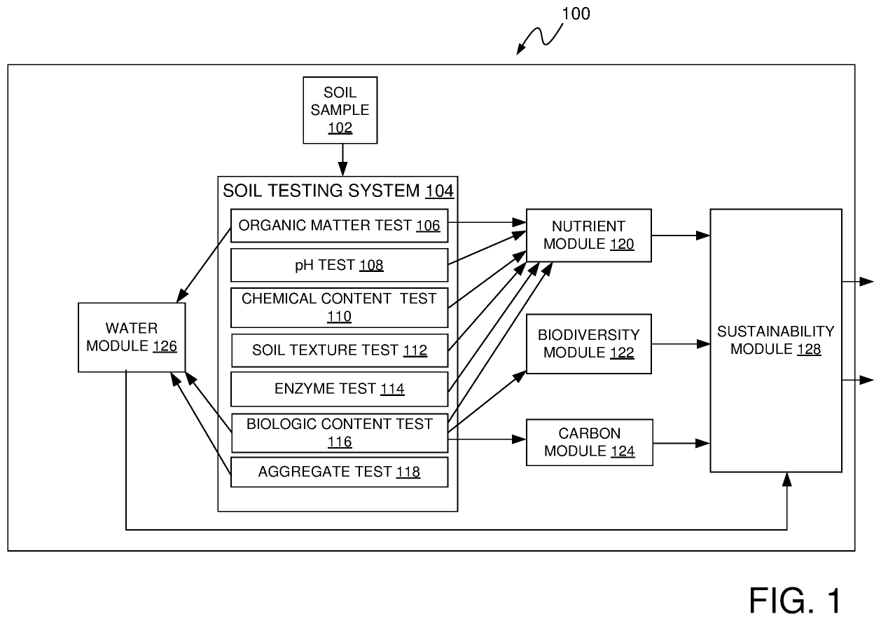

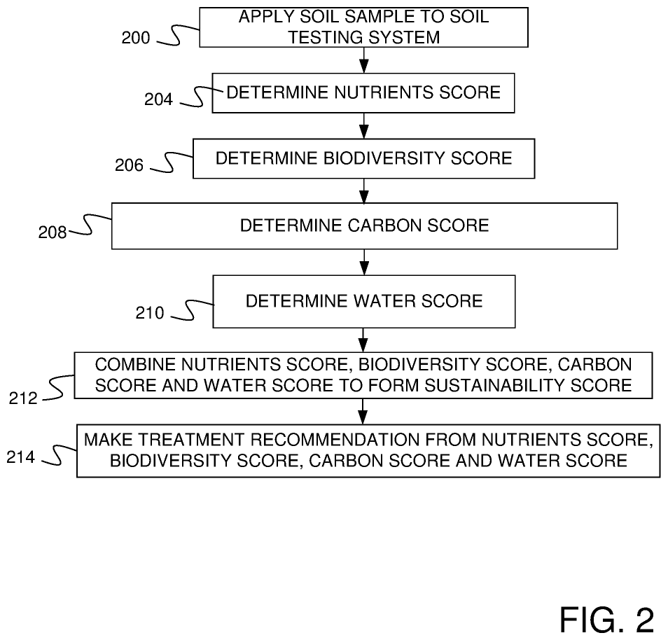

FIG. 1 provides a block diagram of a system 100 for generating a sustainability rating and sustainability-based treatment recommendations for a field. FIG. 2 provides a method of processing a soil sample 102 using system 100.

In step 200, soil sample 102 is applied to a soil testing system 104 consisting of a plurality of tests that include one or more of the following: an organic matter test 106, a pH test 108, a chemical content test 110, a soil texture test 112, an enzyme test 114, a biologic content test 116 and an aggregate test 118.

Organic matter test 106 determines the percentage of organic matter in soil sample 102. In accordance with one embodiment, organic matter test 106 involves drying soil sample 102, weighing the dried sample, heating the dried sample to a temperature sufficient to burn off all organic matter in the soil, re-weighing the sample after burning off the organic matter, and using the difference between the two weights as the weight of the organic matter. The weight of the organic matter is then used to determine the percentage of organic matter.

The pH test 108 is a standard pH measurement. Chemical content test 110 determines the chemical content of soil sample 102 including the amount of various elements and chemical compounds in soil sample 102. In accordance with one embodiment, chemical content tests 110 determine an amount of phosphorus, aluminum, and calcium in soil sample 102.

Soil texture test 112 determines the percentages of clay, silt and sand in the soil. In accordance with one embodiment, soil texture test 112 is performed based on the relative settling rates of clay, silt and sand in a liquid.

Enzyme test 114 measures the amounts of particular enzymes in soil sample 102. In particular, enzyme test 114 determines a measure of the labile C-degrading extracellular enzymes and a measure of the recalcitrant C-degrading extracellular enzymes in soil sample 102. In accordance with one embodiment, the measures are determined by reacting the enzymes with a substrate such that the result of the reaction has a different color or fluorescence than the substrate. The degree of color change or fluorescence is then used as a measure of the amount of enzyme in the sample.

Aggregate test 118 measures the ability of soil aggregates to resist disruption when outside forces (usually associated with water) are applied to the sample. In particular, aggregate test 118 measures the stability of aggregates against dissolving in water and against breaking apart when struck. Aggregate test 118 provides an aggregate strength score.

Biologic content test 116 isolate genetic sequences of microbes in soil sample 102 so that various genetic sequences can be counted.

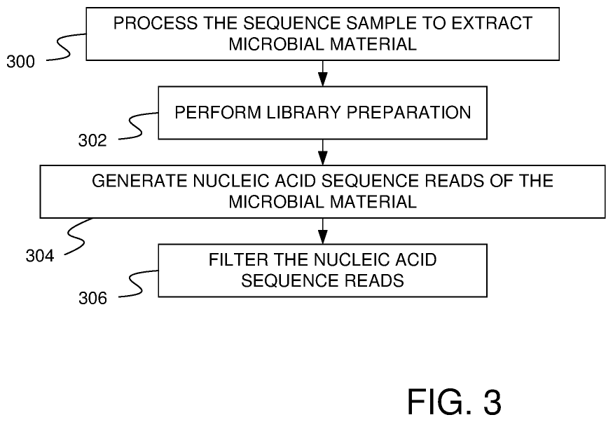

FIG. 3 provides a flow diagram of a method of performing biologic content tests 116. Soil sample 102 is processed at step 300 to extract microbial material (also referred to as microbial genetic material). In some embodiments, soil sample 102 may be stored at −80 degrees Celsius prior to extraction of the microbial material for subsequent analysis. In accordance with one embodiment, soil sample 102 is added to extraction vessels by mass, volume, suspension volume, or another measurement. Cell lysis is performed on the soil sample to release the microbial material including intracellular nucleic acids. Cell lysis may include chemical (buffers or salts), mechanical (bead beating or sonication), or thermal (e.g., freezing, free-thaw cycling, or microwaving) processes. Soil and the released microbial material are separated. Cellular debris may be removed using chemical precipitation or centrifugation. Additionally, contaminants may be removed using precipitation and elution of the microbial material. The microbial material may be prepared using fluorescent dyes or gels for downstream assay or spectroscopy.

In some embodiments, the nucleic acids of the microbial material may be processed prior to library preparation. For example, target genes or genome regions may be enriched for polymerase chain reaction (PCR) amplification or amplicon sequencing. Targeted DNA primers may be used to flank a region of interest. In some use cases, DNA fragment size may be controlled chemically using size selection gel beads, physically using ultrasonic shearing, or enzymatically using transposase fragmentation.

At step 302 sequencing library preparation is performed on the extracted microbial material. Library preparation may include attaching sequencing adapters or tags to nucleic acids to facilitate reading of the nucleic acids. Sequencing tags may be unique to each sample (e.g., serving as a barcode) and enable identification of sequenced data associated with each sample in a multiplexed run with multiple samples. Libraries may also be prepared using other suitable methods such as ligation or transposase. In some use cases, library preparation includes protocols from sequencer original equipment manufacturers (OEMs), third party kit providers, or other resources.

Once the sequencing library is prepared, the library or a portion of the library can be sequenced such that nucleic acid sequence reads of the microbial material are generated at step 304 using one or more techniques. In some embodiments, a sequencer performs sequencing (e.g., of DNA or RNA) and outputs sequence reads of the microbial material. In some embodiments, the nucleic acid sequence reads are generated using next generation sequencing (NGS) techniques including synthesis technology (ILLUMINA®), pyrosequencing (454 LIFE SCIENCES), ion semiconductor technology (Ion Torrent sequencing), single-molecule real-time sequencing (PACIFIC BIOSCIENCES®), or nanopore sequencing (OXFORD NANOPORE TECHNOLOGIES). DNA sequencing can also be performed as described in Sanger et al. (PNAS 74:5463, (1977)) and the Amersham International plc sequencing handbook, which methods are incorporated by reference herein.

At step 306, the nucleic acid sequence reads are filtered. For example, low quality sequence reads are discarded. Sequence reads can be considered of low quality by determining that a length of the sequence read is less than a threshold value, the sequence read includes at least a threshold number of ambiguous bases, or a read quality score (e.g., determined using a third-party tool) is less than a threshold score, for example.

The biologic sequence reads are then used to determine gene counts for selected genes. Some of these genes are selected based on their association with functions performed in the soil and other genes are selected based on what organisms the genes are present in. The genes can be identified from multiple sources including the MetaCyc database, the Kyoto Encyclopedia of Genes and Genomes (KEGG) and SEED gene ontologies. Further data sources are used to obtain additional gene annotation sources or models, including the UniProt, Pfam, and InterPro databases. These databases generally represent known molecular biology across organisms as organized for varying purposes which are not commonly organized to represent element cycling, soils, or agriculture.

The sequence reads are assigned to the corresponding genes in the reference databases in order to determine counts of each gene. The gene counts are then normalized using total reads or gene hits, rarefaction, normalization by single copy marker genes, or other transformations. Reads or normalized read counts of subunits of a gene may be combined. For example, the counts of subunits of a gene are averaged in one embodiment to produce a count for the gene.

Examples of genes that are counted include genes known to be part of specific prokaryotic organisms, genes known to be part of specific fungi, genes known to be part of specific protozoa, genes from organisms that thrive in low-oxygen environments, genes from organisms that thrive in high-oxygen environments, genes responsible for denitrification, genes that contribute to mineralization of phosphorus, genes that contribute to solubilization of phosphorus, genes in microorganisms that perform nitrogen fixation, genes or parts of genes associated with microbial growth rate, genes or parts of genes indicative of microbial biomass, genes associated with releasing nitrous oxide, and genes associated with reducing nitrous oxide to nitrogen.

As part of counting genes or parts of genes associated with microbial growth rate, a portion of the sample may be placed in a controlled environment that allows microbes to grow and uptake certain chemicals into the microbes DNA before the DNA is separated and counted as discussed above in FIG. 3.

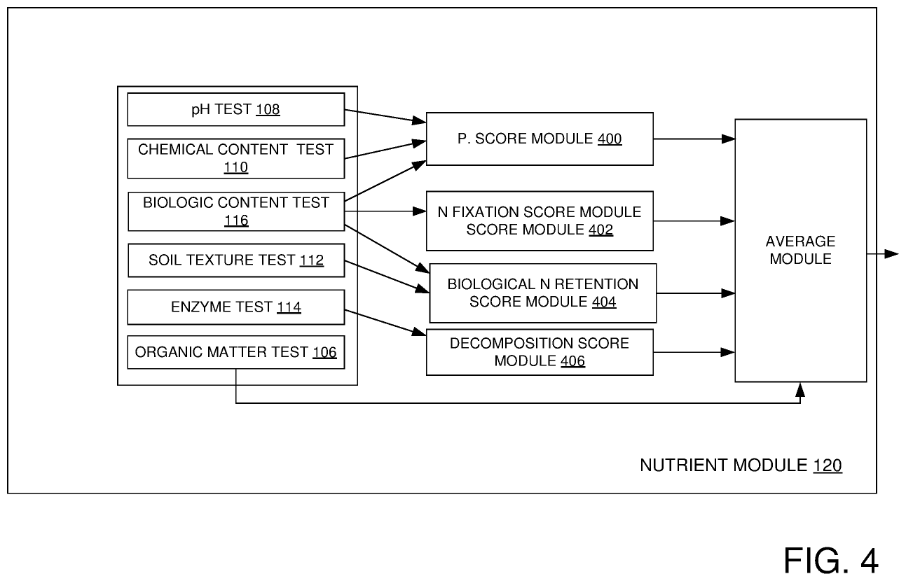

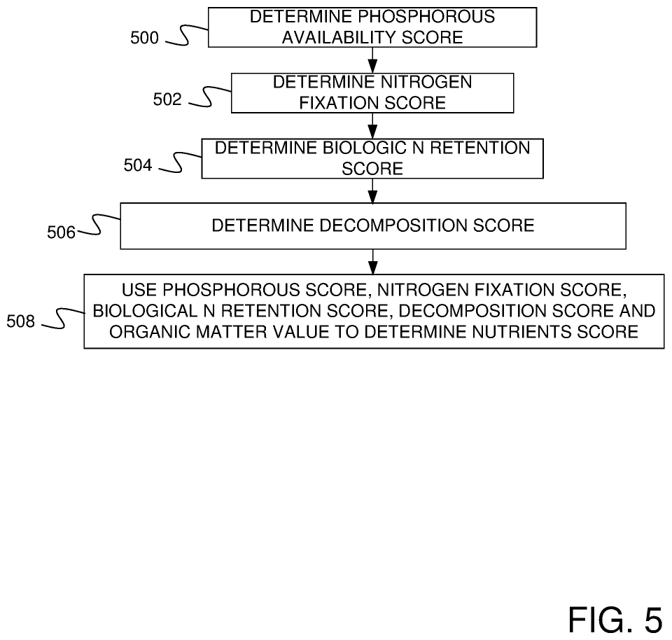

Returning to FIG. 2, at step 204, a nutrients score is determined by a nutrient module 120 of FIG. 1. The nutrients score indicates the degree to which the soil is able to retain nutrients and make those nutrients available to plants. FIG. 4 provides a block diagram of an embodiment of nutrient module 120 and FIG. 5 provides a flow diagram of a method of determining a nutrients score using the nutrient module of FIG. 4.

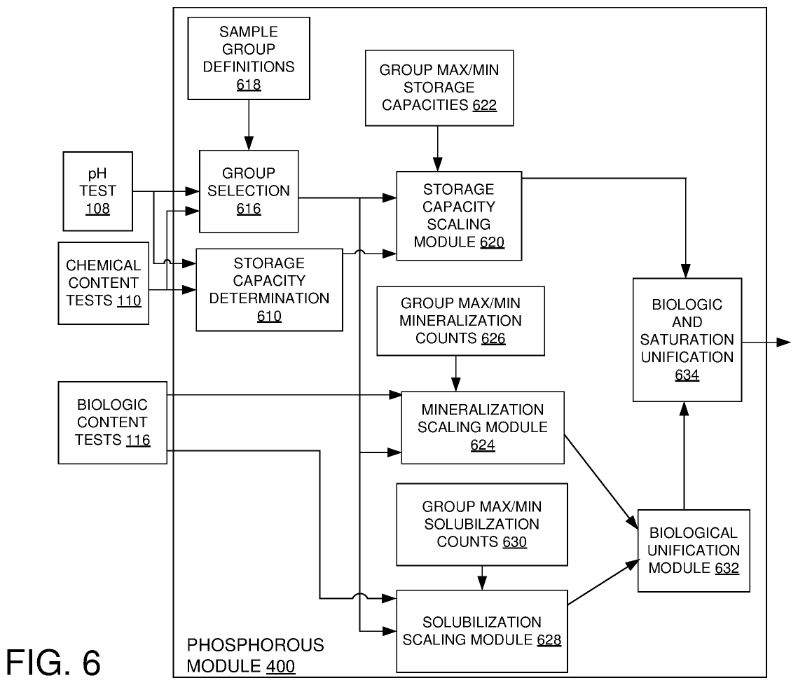

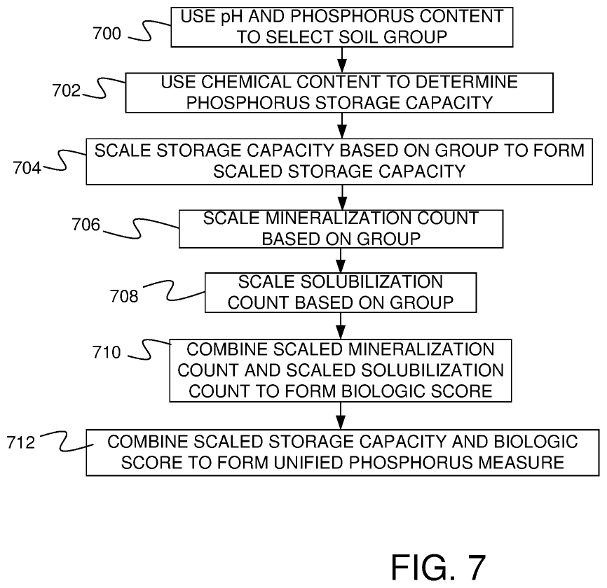

In step 500, a phosphorous availability score is determined by a phosphorous score module 400 using the results of pH test 108, chemical content test 110 and biologic content tests 116. FIG. 6 provides a block diagram of phosphorous score module 400 and FIG. 7 provides a method of determining the phosphorous availability score using phosphorous score module 400.

At step 700, the pH determined by pH test 108 and the phosphorus content of the soil sample determined by chemical content tests 110 are provided to a group selection module 616. Group selection module 616 uses the pH and the phosphorus content to select a sample group for soil sample 102 using sample group definitions 618. In accordance with one embodiment, each sample group is defined as samples that have homogeneous characteristics based on multiple co-factors including the pH of the soil and the phosphorus content of the soil.

At step 702, a phosphorus storage capacity module 610 uses the chemical content of the soil to determine a measure of phosphorus saturation, which provides an indication of how close the soil is to becoming saturated with phosphorus. In accordance with one embodiment, the measure of phosphorus saturation is determined by first determining a phosphorus storage capacity using the amount of phosphorus, aluminum and calcium in soil sample 102 as well as the pH of soil sample 102.

At step 704, the phosphorus storage capacity is scaled by a saturation scaling module 620. In one embodiment, this scaling is performed using a maximum phosphorus storage capacity and a minimum phosphorus storage capacity determined for the sample group of soil sample 102 provided by group selection 616. Saturation scaling module 120 retrieves the maximum and minimum phosphorus storage capacities for the sample group from group maximum/minimum storage capacities 622. In accordance with one embodiment, the maximum and minimum phosphorus storage capacities are determined from phosphorus storage capacities of a collection of soil samples that fall within the sample group. In particular, the minimum storage capacity is calculated as the storage capacity of the soil sample marking the first quartile in the collection of soil samples minus 1.5 times the interquartile difference in storage capacities. The maximum storage capacity is calculated as the storage capacity of the soil sample marking the third quartile in the collection of soil samples of the group plus 1.5 times the interquartile difference in storage capacities. The scaled phosphorus storage capacity is then calculated as one hundred times the value of the storage capacity provided by saturation determination module 110 minus the minimum storage capacity for the group divided by the difference between the maximum storage capacity for the group minus the minimum storage capacity for the group. Thus, the scaled phosphorus storage capacity has a value between zero and one hundred, with larger values indicating more phosphorus sorption sites are filled in the soil. The resulting scaled phosphorus storage capacity provides the measure of phosphorus saturation.

At step 706, a scaled mineralization score is determined by a mineralization scaling module 624. In one embodiment, this is performed by scaling the mineralization count provided by biologic content tests 116, where the mineralization count is the count of the genes that contribute to mineralization of phosphorous determined in the method of FIG. 3. The scaling is performed using a maximum phosphorus mineralization count and a minimum phosphorus mineralization count for the sample group of soil sample 102. Mineralization scaling module 624 retrieves the maximum and minimum phosphorus mineralization count for the sample group from group maximum/minimum mineralization counts 626. In accordance with one embodiment, the maximum and minimum mineralization counts are determined from mineralization counts of a collection of soil samples that fall within the sample group. In particular, the minimum mineralization count is calculated as the mineralization count of the soil sample marking the first quartile in the collection of soil samples for the group minus 1.5 times the interquartile difference in mineralization counts within the group. The maximum mineralization count is calculated as the mineralization count of the soil sample marking the third quartile in the collection of soil samples of the group plus 1.5 times the interquartile difference in mineralization counts within the group. The scaled mineralization count is then calculated as one hundred times the value of the mineralization count provided by biologic content tests 116 minus the minimum mineralization count for the group divided by the difference between the maximum mineralization count for the group minus the minimum mineralization count for the group. Thus, the scaled mineralization count has a value between zero and one hundred. This scaled mineralization count is also referred to as a mineralization function measure.

At step 708, a scaled solubilization score is determined by a solubilization scaling module 628. In one embodiment, this is performed by scaling the solubilization count provided by biologic content tests 116, where the solubilization count is the count of the genes that contribute to solubilization of phosphorus determined in the method of FIG. 3. The scaling is performed by scaling the solubilization count using a maximum phosphorus solubilization count and a minimum phosphorus solubilization count for the sample group of soil sample 102. Solubilization scaling module 128 retrieves the maximum and minimum phosphorus solubilization count for the sample group from group maximum/minimum solubilization counts 630. In accordance with one embodiment, the maximum and minimum solubilization counts are determined from solubilization counts of a collection of soil samples that fall within the sample group. In particular, the minimum solubilization count is calculated as the solubilization count of the soil sample marking the first quartile in the collection of soil samples for the group minus 1.5 times the interquartile difference in solubilization counts within the group. The maximum solubilization count is calculated as the solubilization count of the soil sample marking the third quartile in the collection of soil samples of the group plus 1.5 times the interquartile difference in solubilization counts within the group. The scaled solubilization count is then calculated as one hundred times the value of the solubilization count provided by biologic content tests 116 minus the minimum solubilization count for the group divided by the difference between the maximum solubilization count for the group minus the minimum solubilization count for the group. Thus, the scaled solubilization count has a value between zero and one hundred. This scaled solubilization count is also referred to as a solubilization function measure.

At step 710, a biologic unification module 632 combines the scaled mineralization count with the scaled solubilization count to provide a biologic phosphorous score. In accordance with one embodiment, the biologic phosphorous score is formed as a weighted sum of the scaled mineralization count and the scaled solubilization count. In accordance with one embodiment, the weights used to form the biologic score are selected so that the biologic phosphorous score has the same range of values as the scaled phosphorus storage capacity. For example, when the scaled phosphorus storage capacity has a range between zero and one hundred and the scaled mineralization count and the scaled solubilization count each have a range between zero and one hundred, the weights are selected such that the sum of the weights is one thereby making the biologic phosphorous score range between zero and one hundred. In one specific embodiment, the weights for the scaled mineralization count and the scaled solubilization count are the same.

At step 712, the biologic score is combined with the scaled phosphorus storage capacity by biologic and saturation unification module 634 to form the phosphorous availability score. In accordance with one embodiment, the phosphorous availability score is the weighted sum of the biologic phosphorous score and the scaled phosphorus storage capacity.

Returning to FIG. 5, at step 502, a nitrogen fixation score is determined by a nitrogen fixation score module 402 of FIG. 4 using the results of biologic content tests 116. In particular, the nitrogen fixation score is determined by normalizing the count of microorganisms that perform nitrogen fixation provided by biologic content tests 116. Nitrogen fixation is the ability to convert nitrogen in the atmosphere into a form of nitrogen that can be made available to plants.

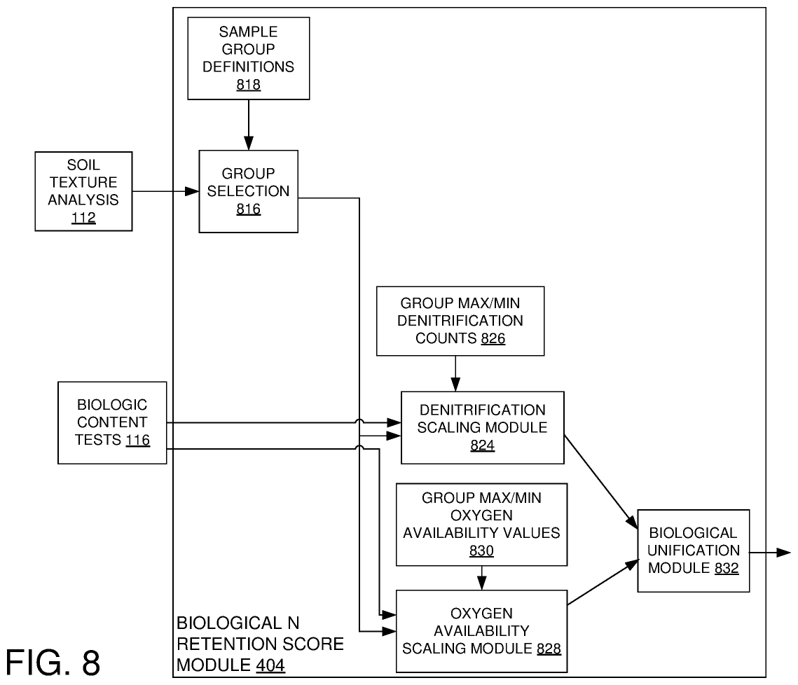

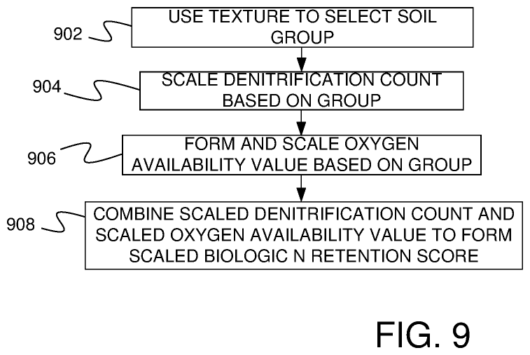

In step 504 of FIG. 5, a biological nitrogen retention score is determined by a biological nitrogen retention score module 404 using the results of biologic content tests 116 and soil texture test 112. FIG. 8 provides a block diagram of biological nitrogen retention score module 404 and FIG. 9 provides a method of determining the biological nitrogen retention score using biological nitrogen retention score module 404.

In step 902 of FIG. 9, the soil texture determined by soil texture test 112 is provided to a group selection module 816 in biological nitrogen retention score module 404. Group selection module 816 uses the soil texture and a set of sample group definitions 818 to select a sample group for soil sample 102. In accordance with one embodiment, each sample group is defined by a range of percentages for each of clay, silt and sand. In accordance with one embodiment, the sample groups are defined so that samples within each group have homogeneous characteristics with regards to nitrogen retention.

At step 904, the count of genes responsible for denitrification produced by biologic content tests 116 is converted into a scaled denitrification score by a denitrification scaling module 824. In one embodiment, this is performed by scaling the denitrification counts using a maximum denitrification count and a minimum denitrification count for the sample group of soil sample 102. Denitrification scaling module 824 retrieves the maximum and minimum denitrification counts for the sample group from group maximum/minimum denitrification counts 826. In accordance with one embodiment, the maximum and minimum denitrification counts are determined from denitrification counts of a collection of soil samples that fall within the sample group. In particular, the minimum denitrification count is calculated as the denitrification count of the soil sample marking the first quartile in the collection of soil samples for the group minus 1.5 times the interquartile difference in denitrification counts within the group. The maximum denitrification count is calculated as the denitrification count of the soil sample marking the third quartile in the collection of soil samples of the group plus 1.5 times the interquartile difference in denitrification counts within the group. The scaled denitrification count is then calculated as one hundred times the value of the denitrification count provided by biologic content tests 116 minus the minimum denitrification count for the group divided by the difference between the maximum denitrification count for the group minus the minimum denitrification count for the group. Thus, the scaled denitrification count has a value between zero and one hundred.

At step 906, an oxygen availability value is formed and scaled by an oxygen availability scaling module 828. In accordance with one embodiment, the oxygen availability value is formed by applying function to the count of genes from organisms that thrive in low-oxygen environments and the count of genes from organisms that thrive in high-oxygen environments provided by biologic content tests 116. In accordance with one embodiment, the function consists of dividing the count of genes from organisms that thrive in low-oxygen environments by the count of genes from organisms that thrive in high-oxygen environments.

The oxygen availability value is converted into a scaled oxygen availability score by scaling the oxygen availability value using a maximum oxygen availability value and a minimum oxygen availability value for the sample group of soil sample 102. Oxygen availability scaling module 828 retrieves the maximum and minimum oxygen availability values for the sample group from group maximum/minimum oxygen availability values 830. In accordance with one embodiment, the maximum and minimum oxygen availability values are determined from oxygen availability values of a collection of soil samples that fall within the sample group. In particular, the minimum oxygen availability value is calculated as the oxygen availability value of the soil sample marking the first quartile in the collection of soil samples for the group minus 1.5 times the interquartile difference in oxygen availability values within the group. The maximum oxygen availability value is calculated as the oxygen availability value of the soil sample marking the third quartile in the collection of soil samples of the group plus 1.5 times the interquartile difference in oxygen availability values within the group. The scaled oxygen availability value is then calculated as one hundred times the value of the oxygen availability value minus the minimum oxygen availability value for the group divided by the difference between the maximum oxygen availability value for the group minus the minimum oxygen availability value for the group. Thus, the scaled oxygen availability value has a value between zero and one hundred.

At step 908, a biologic unification module 832 combines the scaled denitrification count with the scaled oxygen availability value to provide a biologic N retention score. In accordance with one embodiment, the biologic N retention score is formed as a weighted sum of the scaled denitrification count and the scaled oxygen availability value.

Returning to FIG. 5, after the biologic N retention score has been determined, a decomposition score is determined by a decomposition score module 406 of FIG. 4 at step 506. The decomposition score represents the ability of microbial-mediated processes in the soil to make nutrients in organic matter available to plants. The microbial-mediate processes are facilitated by extracellular enzymes that breakdown organic matter. The decomposition score is formed by decomposition score module 406 using the measure of labile C-degrading extracellular enzymes detected by enzyme tests 114 and the measure of recalcitrant C-degrading extracellular enzymes detected by enzyme tests 114. In particular, the decomposition score is determined by dividing the measure of labile C-degrading extracellular enzymes by the measure of recalcitrant C-degrading extracellular enzymes.

At step 508, an averaging module 408 of FIG. 4 averages the phosphorous availability, the nitrogen fixation score, the biological N retention score, the decomposition score and the organic matter measure from organic matter test 106 to produce the nutrients score.

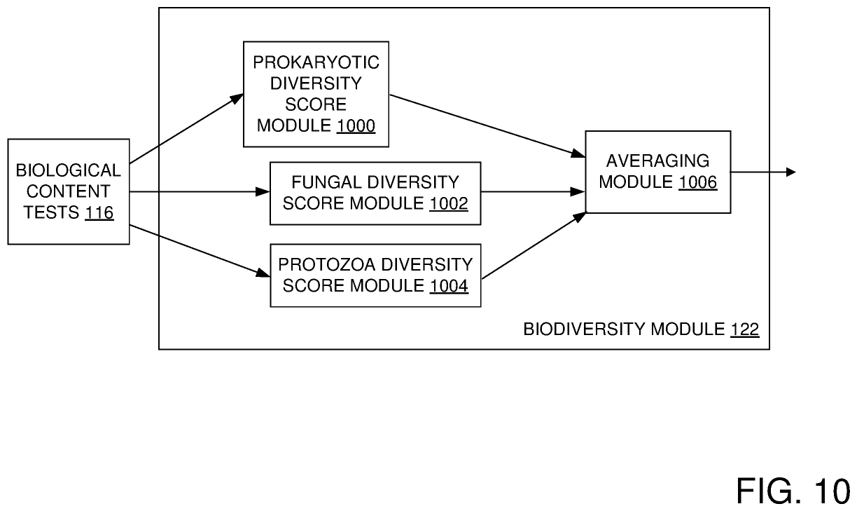

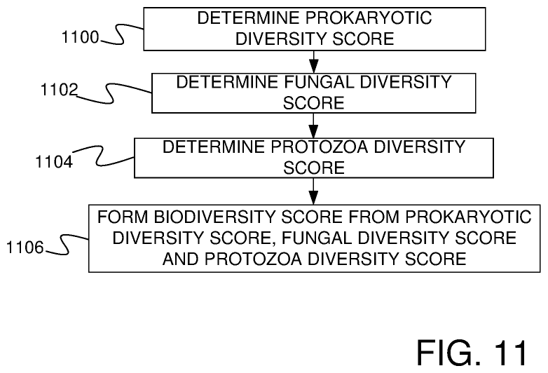

Returning to FIG. 2, at step 206, a biodiversity module 122 determines a biodiversity score using the results of biologic content test 116. Soil biodiversity plays a vital role in the soil ecosystem as soil organisms are responsible for nutrient cycling, regulating the dynamics of soil organic matter, soil carbon sequestration, and greenhouse gas emissions. Having a diverse microbe population increases the likelihood that the soil will be able to perform all of the functions necessary to achieve sustainable agriculture. FIG. 10 provides a block diagram of biodiversity module 122 and FIG. 11 provides a flow diagram of a method of forming the biodiversity score.

In step 1100 of FIG. 11, a prokaryotic diversity score module 1000 determines a prokaryotic diversity score based on the results of biologic content tests 116. In particular, prokaryotic diversity score module 1000 uses the counts of genes known to be part of specific prokaryotic organisms to determine the number of different prokaryotic organisms that are in soil sample 102 (richness) as well as the relative abundance of each prokaryotic organism (balance). Prokaryotic diversity score module 1000 then uses the richness and the balance to set the prokaryotic diversity score such that soil samples with higher richness and better balance (different organisms appearing with equal abundance) have a higher prokaryotic diversity score. In accordance with one embodiment, the prokaryotic diversity score takes into account both bacteria and archaea which carry out certain soil processes such as nitrification.

In step 1102, a fungal diversity score module 1002 determines a fungal diversity score based on the results of biologic content tests 116. In particular, fungal diversity score module 1002 uses the counts of genes known to be part of specific fungi to determine the number of different fungi that are in soil sample 102 (richness) as well as the relative abundance of each fungus (balance). Fungal diversity score module 1002 then uses the richness and the balance to set the fungal diversity score such that soil samples with higher richness and better balance (different fungi appearing with equal abundance) have a higher fungal diversity score.

In step 1104, a protozoa diversity score module 1004 determines protozoa diversity score based on the results of biologic content tests 116. In particular, protozoa diversity score module 1004 uses the counts of genes known to be part of specific protozoa to determine the number of different protozoa that are in soil sample 102 (richness) as well as the relative abundance of each protozoon (balance). Protozoa diversity score module 1004 then uses the richness and the balance to set the protozoa diversity score such that soil samples with higher richness and better balance (different organisms appearing with equal abundance) have a higher protozoa diversity score.

Fungi and protozoa play key functional roles in soils, namely decomposition, nutrient cycling and soil structural formation. As such, the fungal diversity score and the protozoa diversity score indicate the likelihood that the soil will be able to perform these functions.

At step 1106, an averaging module 1006 averages the prokaryotic diversity score, the fungal diversity score and the protozoa diversity score to form the biodiversity score.

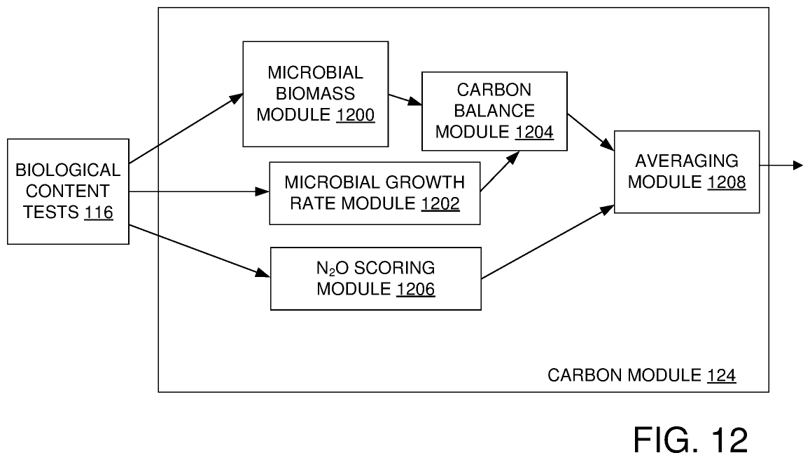

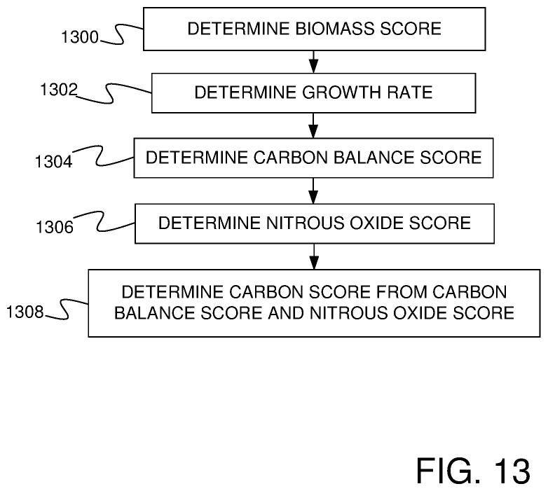

Returning to FIG. 2, at step 208, a carbon module 124 determines a carbon score using the results of biologic content tests 116. FIG. 12 provides a block diagram of carbon module 124 and FIG. 13 provides a flow diagram of a method of forming the carbon score. The carbon score indicates the degree to which the soil is able to sequester greenhouse gases such as carbon dioxide and nitrous oxide.

In step 1300 of FIG. 13, a microbial biomass module 1200 uses the results of biologic content tests 116 to determine the microbial biomass in the soil sample. As microbes grow, they convert decaying plant material into microbial biomass. When the microbes die, the microbes' residue accumulates on mineral-associated soil fractions, thereby sequestering carbon. As such, the microbial biomass represents the degree to which the soil is sequestering carbon. In accordance with one embodiment, the amount of DNA in the soil sample is measured and is applied to a function to produce the microbial biomass.

In step 1302, a microbial growth rate module 1202 uses the results of biologic content tests 116 to determine the growth rate of microbes in the soil sample. Like microbial biomass, microbial growth rate indicates the degree to which the soil is sequestering carbon within microbes. In accordance with one embodiment, microbial growth rate module 1202 uses a count of the parts of genes indicative of growth rate to determine the growth rate of microbes. These parts of genes can include chemicals that were introduced into a controlled environment during a time when microbes were allowed to grow.

At step 1304, a carbon balance module 1204 uses the microbial biomass from microbial biomass module 1200 and the microbial growth rate determined by microbial growth rate module 1202 to form a carbon balance score that indicates the relative balance between the amount of carbon being sequestered into the soil by microbes and the amount of carbon being released into the atmosphere as CO₂ by the microbes.

At step 1306, a nitrous oxide scoring module 1206 determines a nitrous oxide score based on results from biologic content tests 116. In particular, nitrous oxide scoring module 1206 uses the counts of genes associated with releasing nitrous oxide (thereby releasing a greenhouse gas into the atmosphere), and the counts of genes associated with reducing nitrous oxide to nitrogen (thereby reducing the release of a greenhouse gas into the atmosphere) to determine the nitrous oxide score. As a result, the nitrous oxide score indicates whether the microbes in the soil sample are more likely to release nitrous oxide or convert nitrous oxide into nitrogen in the soil.

At step 1308, an averaging module 1208 averages the carbon balance score and the nitrous oxide score to form a carbon score that represents the impact the soil has on greenhouse gases such as carbon dioxide and nitrous oxide.

Returning to FIG. 2, after the carbon score has been determined, a water score is determined by a water score module 126 at step 210. The water score indicates the ability of the soil to absorb and retain water for later use. Soils that are able to retain water for later use generally require less water to be applied by the farmer resulting in lower costs and lower environmental impact. In general, soils that are able to retain water are considered more sustainable.

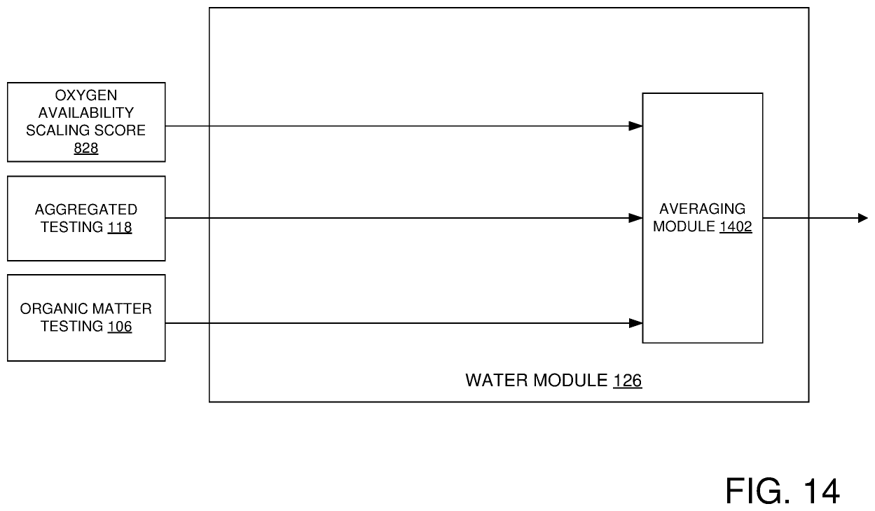

FIG. 14 provides a block diagram of water score module 126, which includes an averaging module 1402. Averaging module 1402 forms the water score as an average of the scaled oxygen availability score provided by oxygen availability scaling module 828 of FIG. 8, the percentage of organic matter in the soil provided by organic matter testing 106 and the aggregate strength score provided by aggregate testing 118. The oxygen availability score is used because the amount of available oxygen is related to the degree to which the soil is retaining water. In general, as the amount of water increases in the soil, the amount of available oxygen decreases. The percentage of organic matter is used to determine the water score because increases in organic matter content result in increased aggregation and improved soil structure, which lead to improved water infiltration rates and retention. Each one percent increase in soil organic matter helps soil hold 20,000 more gallons of water per acre. The aggregate stability is used because the spaces between the aggregates provide volumes for retention and exchange of air and water. Thus, the ability of aggregates to retain their shape results in more open volumes for retaining water.

In step 212 of FIG. 2, a sustainability module 128 of FIG. 1 determines a sustainability score from the nutrients score, the biodiversity score, the carbon score and the water score. In one embodiment, the sustainability score is the average of the nutrients score, the biodiversity score, the carbon score and the water score and represents a level of sustainability for how a portion of a field is being farmed. In particular, the sustainability score indicates the ability of a field to retain nutrients, the level of microbe biodiversity in the field, the ability of the field to sequester greenhouse gases and the ability of the field to retain water. Thus, the sustainability score indicates the degree to which the field is capable of being farmed in a sustainable manner. A respective sustainability score can be determined for a number of different fields and can be used to rank fields based on sustainability and to select fields that will be used as sources of agricultural products. For example, a manufacturer that uses one or more crops to produce a product can select which fields they will buy their crops from so as to achieve a sustainability level for their product.

In step 214, sustainability module 128 makes treatment recommendations for the portion of the field that soil sample 102 was taken from based on the nutrients score, the biodiversity score, the carbon score and the water score. For example, if the nutrients score is low, the treatment recommendation will be designed to improve the nutrients score by, for example, recommending the addition of organic matter to the field or the addition of microbes that will assist in decomposing organic matter in the field so that the field is better able to retain nutrients and make nutrients available to plants. If the biodiversity score is low, the recommendation can include adding microbes that are missing from the field so as to improve biodiversity. If the carbon score is low, the recommendation can include adding microorganisms that improve the sequestration of greenhouse gasses. If the water score is low, the recommendation can include adding organic matter to the soil or reducing compaction so as to improve the ability of the soil to retain water.

Currently, large-scale purchasers of agricultural products are unable to determine the sustainability of the crops they purchase. In particular, computer user interfaces are currently unable to show a comparison of sustainability measures for crops that were purchased by an entity and the same sustainability measures for crops grown in other fields, by other farming operations, in other counties or other states. As a result, purchasers are unable to assess whether they should switch vendors for their crop so as to encourage farmers to adopt more sustainable farming practices.

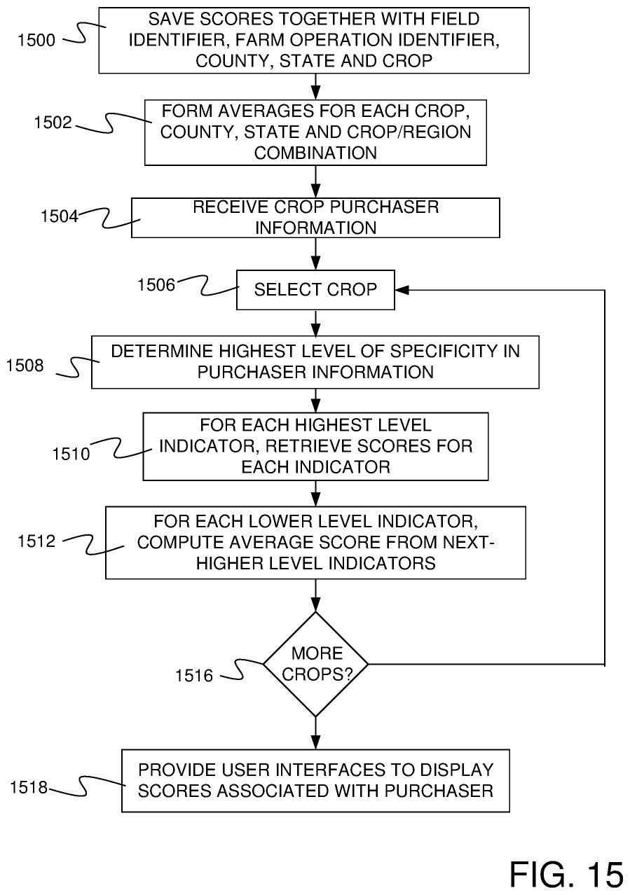

FIG. 15. provides a block diagram of method of using the sustainability measure determined in FIG. 2 to generate user interfaces that indicate to a crop purchaser how the crops they purchased compare to crops grown on other fields, by other farming operations, in other counties or in other states.

In step 1500, for each of a collection of fields, the sustainability score formed in step 212 of FIG. 2 is stored in a database together with the nutrient score, the biodiversity score, the carbon score and the water score of the field. In addition, multiple pieces of metadata are stored with scores including a field identifier, a farm operation identifier, a county identifier, a state identifier and a crop designation so that the scores can be associated with each piece of metadata. The field identifier is a unique identifier that identifies the field that the scores were determined for; the farm operation indicates the farm operation responsible for growing the crop on the field; the county identifier indicates the county in which the field resides; the state identifier indicates the state in which the field resides; and the crop designation indicates the crop that was last grown on the field.

Once the database has been filled, average sustainability scores are determined for fields that have a same value for a piece of metadata at step 1502. For example, an average sustainability score is determined for each crop, with each average being computed from the sustainability scores of all the fields that grew that crop. Similarly, an average sustainability score is determined for each farming operation, each county and each state by using the sustainability scores of the fields associated with each of these pieces of metadata. In addition, an average sustainability score is determined for each combination of crop and county and each combination of crop and state. For example, an average sustainability score will be determined from all fields in County A that grew barley and another average sustainability score will be determined from all fields in County B that grew corn. Similarly, an average sustainability score will be determined for all fields in Kansas that grew wheat and another average sustainability score will be determined for all fields in Iowa that grew soy beans.

At step 1504, crop purchaser information is received that includes the crops purchased by a purchaser and at least some information indicating where the crops were grown. This information has different levels of specificity. At the lowest level of specificity, the information will indicate what states the purchased crops were grown in. At the next higher level of specificity, the information will indicate the counties and states where the crops were grown. Above that level of specificity, the grow operation, county and state will be specified, and above that, the individual field, grow operation, county and state will be specified.

At step 1506, a crop is selected for generating a user interface and at step 1508, the highest level of specificity in the purchaser information for that crop is determined. For example, if the grow operations for the crop are found in the purchaser information but the individual fields are not provided, the highest level of specificity is the grow operations.

At step 1510, for each highest-level identifier in the purchaser information, the sustainability score associated with that identifier are retrieved from the database. For example, if the highest level of specificity is the county, the sustainability scores for the counties in the purchaser information are retrieved from the database.

At step 1512, the retrieved scores are combined to form scores for lower levels of specificity. For example, if the highest level of specificity is the counties where the crop was grown, scores are determined for the states at step 1512. In one embodiment, this involves identifying the state that each county identified in the purchaser information is found. An average sustainability score for each state is then determined from the sustainability scores for the counties in the purchaser information that are found in that state.

At step 1516, the method of FIG. 15 determines if more crops were purchased by the purchaser. If more crops were purchased, another crop listed in the purchaser information is selected by returning to step 1506 and steps 1508, 1510 and 1512 are repeated for the new crop.

When all of the crops in the purchaser information have been processed at step 1516, the retrieved and calculated sustainability scores for the purchaser are used to provide user interfaces that allow a purchaser to view sustainability scores associated with their agricultural purchases at step 1518.

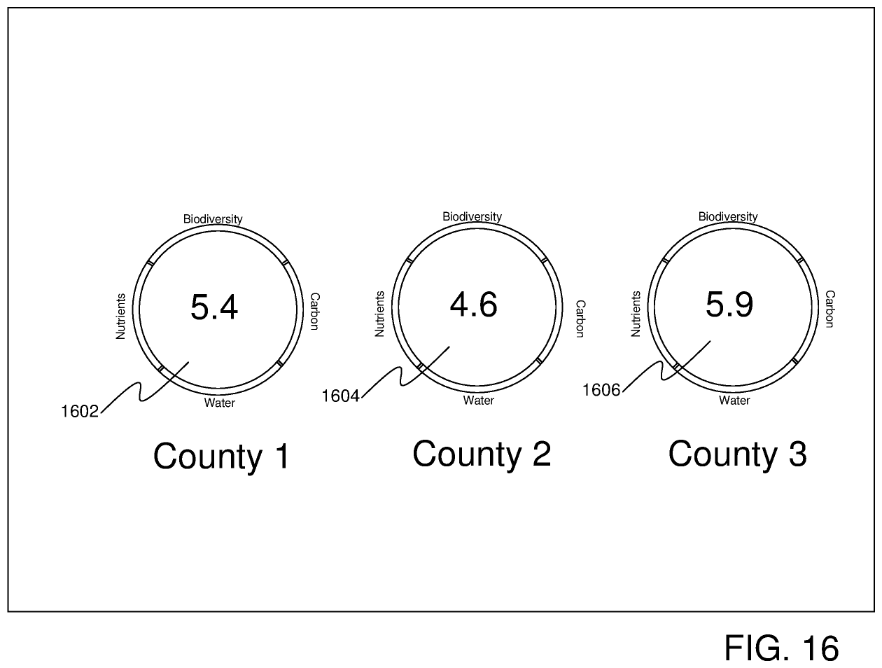

FIG. 16 provides an example of a user interface that displays respective sustainability scores 1600, 1602 and 1604 for three counties. In accordance with one embodiment, the purchaser currently only purchases the crop from fields in county 1. As such, only sustainability score 1600 is associated with the purchaser. Sustainability scores 1602 and 1604 are the average sustainability scores for two other counties where the crop is grown but where the purchaser does not buy from. By showing the sustainability scores of counties 2 and 3 that the purchaser does not buy from together with the sustainability score of county 1 that the purchaser does purchase from, FIG. 16 provides a means for a purchaser to evaluate whether to continue purchasing from county 1.

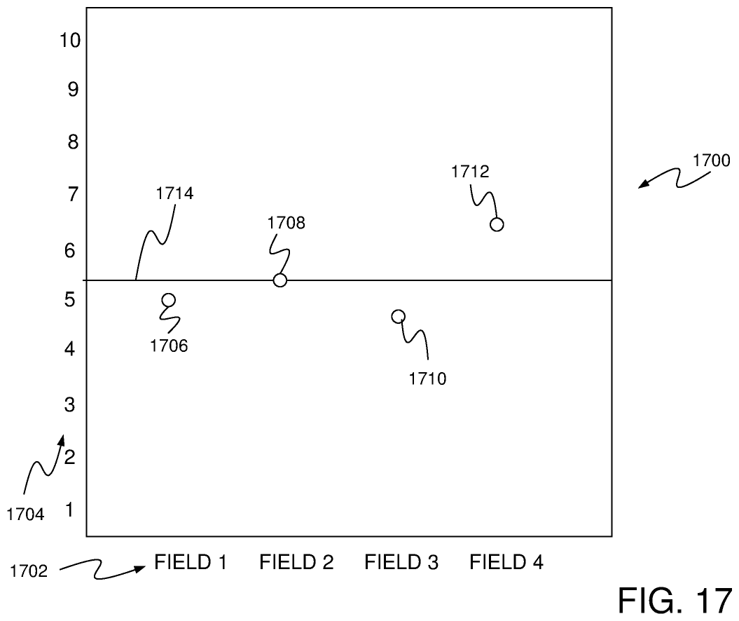

FIG. 17 provides an example of a user interface 1700 that allows a purchaser to evaluate how the sustainability scores of various locations compare to an average sustainability score. In FIG. 17, fields are shown along horizontal axis 1702 and sustainability scores are shown along vertical axis 1704. Circles 1706, 1708, 1710, and 1712 show the sustainability scores for fields 1, 2, 3, and 4. A line 1714 shows an average sustainability score. In accordance with one embodiment, the average sustainability score is the average sustainability score for all fields in the United States. In other embodiments, the average sustainability score is the average for all fields in the same state as fields 1, 2, 3, and 4; or the average for all fields in the same county as fields 1, 2, 3 4. In accordance with one embodiment, one or more of the fields is a field that the purchaser currently purchases the crop from and the other fields are fields that the purchaser does not purchase the crop from.

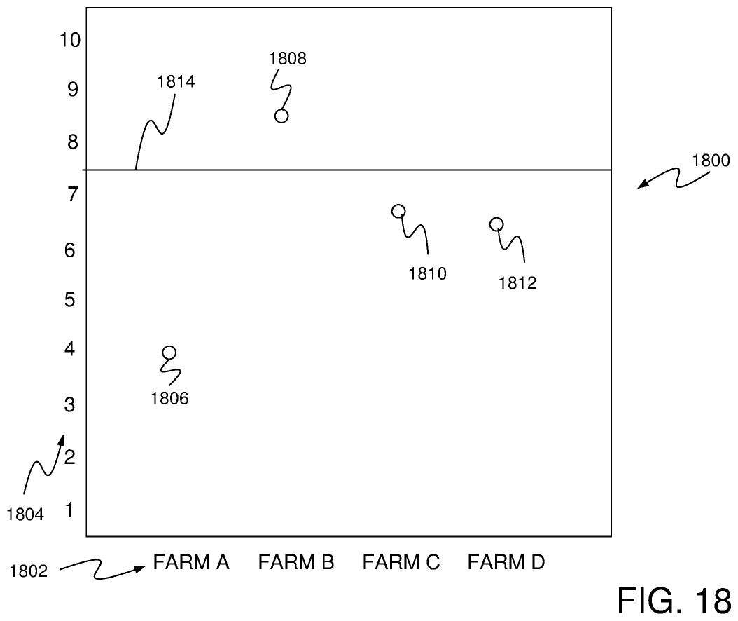

FIG. 18 provides an example of a user interface 1800 that allows a purchaser to evaluate how the sustainability scores of various farm operations compare to an average sustainability score. In FIG. 18, farm operations are shown along horizontal axis 1802 and sustainability scores are shown along vertical axis 1804. Circles 1806, 1808, 1810, and 1812 show the sustainability scores for farm operations A, B, C and D, respectively. A line 1814 shows an average sustainability score. In accordance with one embodiment, the average sustainability score is the average sustainability score for all farm operations growing a particular crop in the United States. In other embodiments, the average sustainability score is the average for all fields in the same state as farm operations A, B, C, and D; or the average for all fields in the same county as farm operations A, B, C, and D. In accordance with one embodiment, one or more of the farm operations is a farm operation that the purchaser currently purchases the crop from and the other farm operations are farm operations that the purchaser does not purchase the crop from.

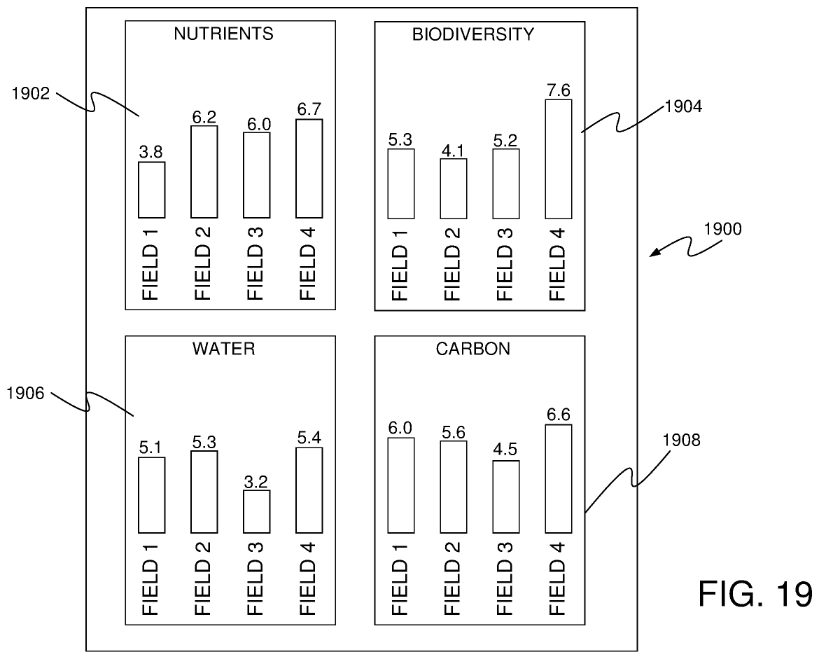

FIG. 19 provides a user interface 1900 in which a purchaser can examine the nutrient scores 1902, biodiversity scores 1904, water scores 1906 and carbon scores 1908 of multiple fields 1, 2, 3 and 4 at the same time. In accordance with one embodiment, the sustainably rating ranges between 1-10 with a tenth degree of specificity, weighted 25% each from the nutrient scores 1902, biodiversity scores 1904, water scores 1906 and carbon scores 1908. In accordance with one embodiment, one or more of the fields are fields that the purchaser currently purchase the crop form and the other fields are fields that the purchaser does not currently purchase the crop from. This allows the purchaser to identify the specific sustainability weakness and strengths of each field.

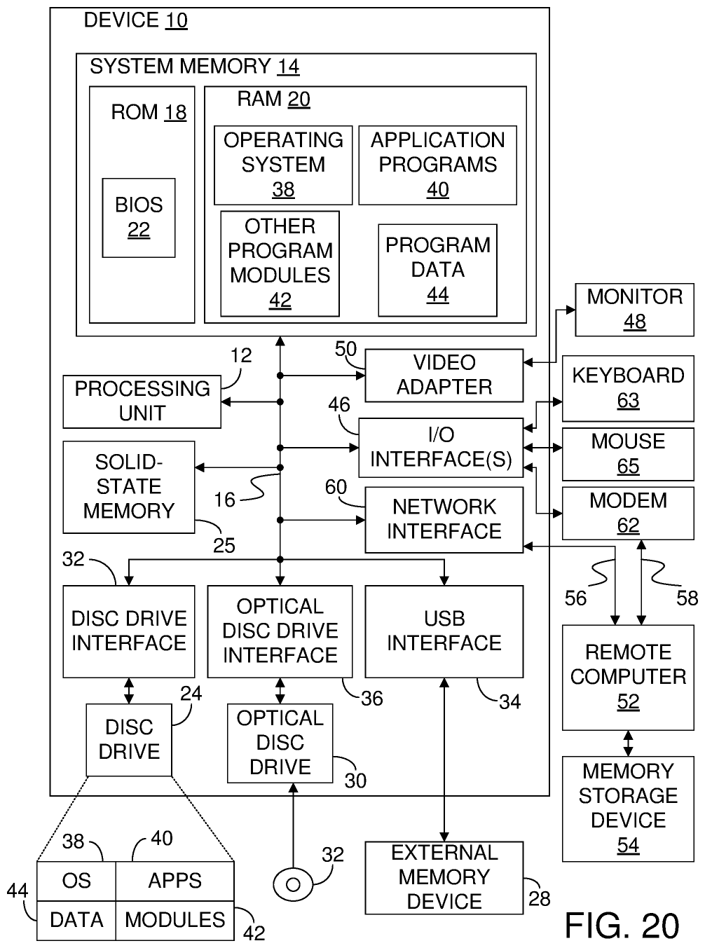

FIG. 20 provides an example of a computing device 10 that can be used to implement each of computing devices 180, 502 and 524 above. Computing device 10 includes a processing unit 12, a system memory 14 and a system bus 16 that couples the system memory 14 to the processing unit 12. System memory 14 includes read only memory (ROM) 18 and random-access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Computing device 10 further includes an optional hard disc drive 24, an optional external memory device 28, and an optional optical disc drive 30. External memory device 28 can include an external disc drive or solid-state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing the modules, engines and APIs discussed above. Program data 44 may include any data used by the systems and methods discussed above.

Processing unit 12, also referred to as a processor, executes programs in system memory 14 and solid-state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 20. The network connections depicted in FIG. 20 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 20 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A method of selecting a treatment recommendation to improve sustainable farming of a field, the method comprising:
obtaining soil from the field;
measuring biologic content in the soil;
using the biologic content to determine an ability of the soil to sequester greenhouse gas;
using the ability of the soil to sequester greenhouse gas to select a treatment recommendation to increase the ability of the soil to sequester greenhouse gas.

2. The method of claim 1 further comprising:
using the biologic content to determine of the degree to which the soil is retaining water; and
using the degree to which the soil is retaining water to select a treatment recommendation to increase the ability of the soil to retain water.

3. The method of claim 1 further comprising:
using the biologic content to determine an ability of the soil to make nutrients available to plants; and
using the ability of the soil to make nutrients available to plants to select a treatment recommendation to increase the ability of the soil to make nutrients available to plants.

4. The method of claim 1 further comprising:
using the biologic content to determine microbe biodiversity in the soil; and
using the microbe biodiversity to select a treatment recommendation to increase the biodiversity in the soil.

5. The method of claim 2 further comprising:
measuring an amount of organic matter in the soil; and
using the amount of organic matter in the soil to determine the ability of the soil to retain water.

6. The method of claim 5 further comprising:
determining an aggregate score for the soil; and
using the aggregate score to determine the ability of the soil to retain water.

7. The method of claim 1 further comprising:
using the biologic content to determine an ability of the soil to retain water;
using the biologic content to determine an ability of the soil to retain nutrients;
using the biologic content to determine microbe biodiversity in the soil; and
using the ability of the soil to sequester greenhouse gas, the ability of the soil to retain water, the ability of the soil to retain nutrients and the microbe biodiversity to determine a sustainability score for the field.

8. A method of selecting a treatment recommendation for a field, the method comprising:
obtaining soil from the field;
measuring biologic content in the soil;
using the biologic content to determine microbe biodiversity in the soil; and
using the microbe biodiversity to select a treatment recommendation to increase the biodiversity in the soil.

9. The method of claim 8 further comprising:
using the biologic content to determine an ability of the soil to sequester greenhouse gas;
using the ability of the soil to sequester greenhouse gas to select a treatment recommendation to increase the ability of the soil to sequester greenhouse gas.

10. The method of claim 8 further comprising:
using the biologic content to determine an ability of the soil to retain water; and
using the ability of the soil to retain water to select a treatment recommendation to increase the ability of the soil to retain water.

11. The method of claim 8 further comprising:
using the biologic content to determine an ability of the soil to retain nutrients; and
using the ability of the soil to retain nutrients to select a treatment recommendation to increase the ability of the soil to retain nutrients.

12. The method of claim 10 further comprising:
measuring an amount of organic matter in the soil; and
using the amount of organic matter in the soil to determine the ability of the soil to retain water.

13. The method of claim 12 further comprising:
determining an aggregate score for the soil; and
using the aggregate score to determine the ability of the soil to retain water.

14. The method of claim 8 further comprising:
using the biologic content to determine an ability of the soil to retain water;
using the biologic content to determine an ability of the soil to retain nutrients;
using the biologic content to determine an ability of the soil to sequester greenhouse gas; and
using the ability of the soil to sequester greenhouse gas, the ability of the soil to retain water, the ability of the soil to retain nutrients and the microbe biodiversity to determine a sustainability score for the field.

15. A method comprising:
collecting soil samples from multiple fields;
using the soil sample of each field to determine a sustainability score for the field, the sustainability score indicating the degree to which the field is capable of being farmed in a sustainable manner.

16. The method of claim 15 further comprising using information related to a purchaser of a crop to retrieve sustainability scores for at least one field and displaying a user interface containing the retrieved sustainability scores.

17. The method of claim 16 wherein displaying the user interface comprises displaying a n average sustainability score.

18. The method of claim 17 wherein the sustainability scores for the at least one field are displayed relative to the average sustainability score.

19. The method of claim 16 wherein the information related to the purchaser comprises an identifier for a field where the crops purchased by the purchaser were grown.

20. The method of claim 19 wherein the information related to the purchaser comprises an identifier for a farm operation that grew the crop purchased by the purchaser.
